(19) United States
(12) Patent Application Publication
(10) Pub. No.: US 2003/0226297 A1
(43) Pub. Date: Dec. 11, 2003

(54) Shut-r-bug

(76) Inventors: Harold Queten Scudieri JR., Toms River, NJ (US); Stephen Jerry Andolora, Toms River, NJ (US)

Correspondence Address: HAROLD Q. SCUDIERI JR., 956 YELLOW BANK ROAD, TOMS RIVER, NJ, 08153, US

(21) Appl. No.: 10/453,279

(22) Filed: Jun. 4, 2003

Related U.S. Application Data
(60) Provisional application No. 60/387,199, filed on Jun. 10, 2002.

(51) Int. Cl. G09F 7/00

(52) U.S. Cl. 40/209; 40/544

(57) ABSTRACT

A device that fits over a license plate of either an automobile, truck or motorcycle that has a circuit built into it and gets hooked up to vehicle power source. The circuit consists of four rows of Infrared led's strategically place in front of the letters and or numbers on the license plate. When powered up the led's will turn on causing them to shine outward from the plate. The human eye can not see the infrared light causing no obstruction to the license plate and will remain readable. When a CCTV camera that is used in the security or law enforcement industry is used for the purpose of photographing your license plate to issue tickets through the mail your license plate will be unreadable and therefore unable to issue you a citation.

The title of the invention is called the “Shut-R-Bug”. This application claims priority over provisional Application No. 60/387199 dated Jun. 10, 2002.

There is no Fed sponsored R&D.

### FIELD OF INVENTION

This invention relates to the field of near infrared wavelength technology, for the purpose of counter-surveillance. SMT (surface mount technology) Infrared diodes are embedded onto a clear license plate cover facing outward which will cause a “Blooming” effect and render the license plate to be un-readable with a surveillance camera, and still remain clear and readable to the human eye.

### BACKGROUND OF INVENTION

With all the security cameras on the road these days, taking pictures of vehicles is almost commonplace. There are cameras at intersections, toll plazas, almost everywhere. With the “SHUT-R-BUG” you could drive knowing that your license plate can't be read with infrared sensitive security cameras that exist today on all major roadways. If a policeman were to look at the license plate, he/or she would have no trouble reading it with the human eye at any angle. A person using this invention could feel secure that surveillance camera operators are not reading their license plate as they drive.

### BRIEF SUMMARY OF INVENTION

The object of this invention is to provide a means so that a user of a motor vehicle can drive with the security that their license plate is not being captured on tape. Another object of this invention is using micro-optic infrared technology. The near IR range of 800-to 1300 nm wavelength diode is used. That wavelength is not visible to the human eye so that the license plate cover is not obscured, blurred or unreadable. The license plate cover would attach over the license plate and be hooked up a switch able battery source, when the car is running or when power is applied, it would power up the IR LED circuit causing the LEDs to light up. When a camera is focused on the plate the led's are shinning right back into the camera lens which will cause a “Blooming” effect in the camera thus rendering a useless image.

### BRIEF DESCRIPTION OF THE DRAWINGS

FIG. 1. Front acrylic

FIG. 2. Front acrylic side view

FIG. 3. Front acrylic top view

FIG. 4. Back acrylic

FIG. 5. Circuit film with led diodes

FIG. 6. Infrared diodes

FIG. 7. Series resistors

FIG. 8. Completed product view

### DETAILED DESCRIPTION

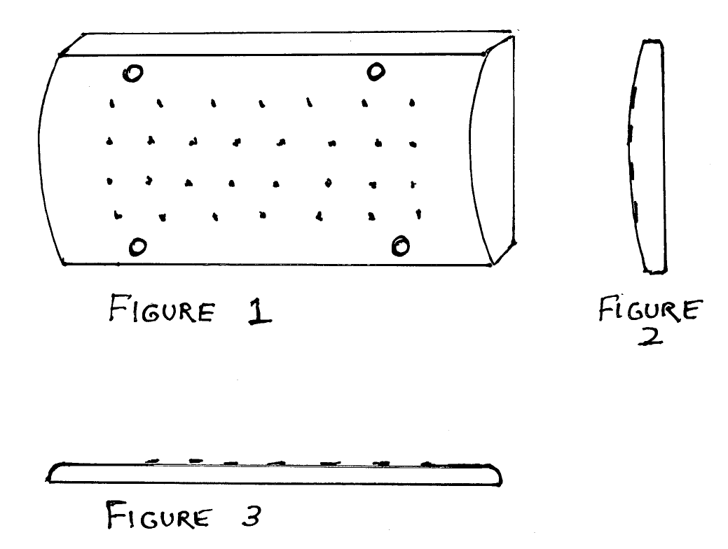

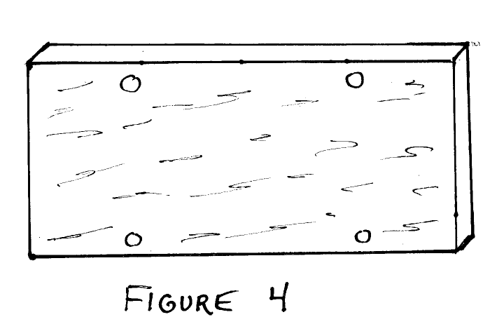

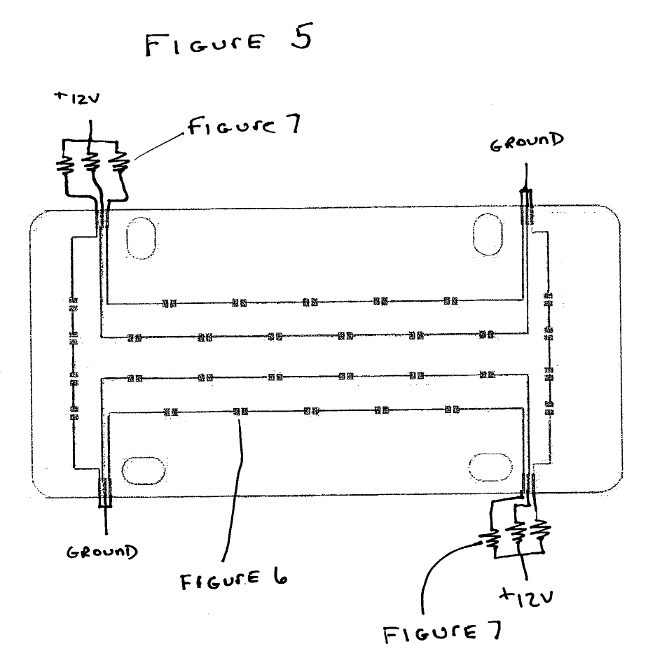

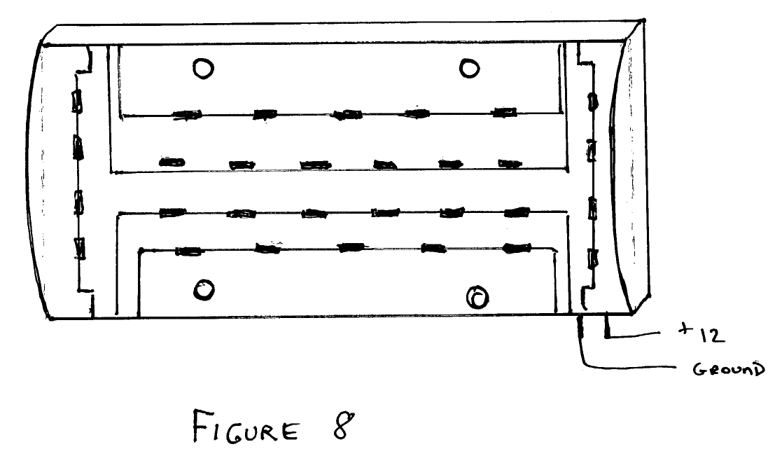

The embodiment of this invention is described in detail of acrylic and circuit description. The invention consists of an electronic circuit encased into two pieces of acrylic. The front piece will consist of a curved piece of clear acrylic 12.5 inches long by 6.5 inches wide by ¼ inch depth with dimples molded into the inside portion centered, see FIG. 1. The dimples will serve as an indent to where the LED's will reside, the dimples will be 1/16 of an inch in diameter by ⅛ inch depth and will be spaced 1.5 inches apart horizontally and 0.75 inches vertically. FIG. 3, is the top view, approximately ¼ inch in thickness; FIG. 2 will be the side view also ¼ inch thickness. The LED's will be soldered on a clear film, FIG. 5 with 4 rows of miniature surface mount technology Infrared diodes (Citizen Electronics part number CL-190IR-X or equivalent) FIG. 6. The first and fourth rows will have seven led's the second and third rows will have eight LED's making up a total of 30 LED's. All rows will have a resistor in series with the LED's to limit the current to manufacture's specifications FIG. 7. The back piece of acrylic, FIG. 4 will sandwich the circuit film with the led's mounted on it. The front and back pieces of acrylic will be sealed together to form a weather tight enclosure, FIG. 8. With only two wires coming out of the unit, one for power and one for ground. These wires will be hooked up through a switch or directly to the car's battery voltage to provide power for the circuit.

1. We claim the benefit of this invention to be, that a license plate with this protective cover on it will not be able to be seen or photographed with a security type camera that is sensitive to infrared light, yet remain totally visible to the naked eye.
